(19) United States
(12) Patent Application Publication
(10) Pub. No.: US 2023/0278654 A1
(43) Pub. Date: Sep. 7, 2023

(54) Guiderail Bicycle Rack

(71) Applicant: Robert Allen Ward, Staffordsville, KY (US)

(72) Inventor: Robert Allen Ward, Staffordsville, KY (US)

(21) Appl. No.: 18/115,047

(22) Filed: Feb. 28, 2023

Related U.S. Application Data
(60) Provisional application No. 63/315,212, filed on Mar. 1, 2022.

(51) Int. Cl. B62H 3/12; B62H 3/08; B62H 3/06

(52) U.S. Cl. CPC B62H 3/12; B62H 3/08; B62H 3/06

(57) ABSTRACT

A vehicle roof top or pickup bed mountable bicycle transport apparatus designed to utilize a novel bicycle loading and unloading method to overcome the difficult loading and unloading drawbacks of currently available apparatuses in the art by effectively reducing the weight of the bicycle, as experienced by the loading and unloading person, by reducing the height the bicycle is required to be lifted to and by offering equal access to the vehicle's entire cargo area available for transporting bicycles. The apparatus consists of a horizontal platform element to roll the bicycle on and along during the loading and unloading processes, raised horizontal guide rail elements to guide and retain the bicycle along and within the confines of the platform during the loading and unloading processes, and vertical stabilizing elements to provide longitudinal and transverse stability for the bicycle during the transport process.

### CROSS REFERENCE TO RELATED APPLICATIONS

This application claims the benefits of U.S. provisional patent application 63/315,212 filed Mar. 1, 2022.

### FIELD OF THE PRESENT INVENTION

The present invention relates generally to apparatuses designed and utilized to transport bicycles on vehicles. The present invention relates more specifically to apparatuses used to transport bicycles on vehicle roof tops and over top of pickup truck beds.

### BACKGROUND OF THE PRESENT INVENTION

Bicyclists often use vehicle mounted bicycle racks to transport their bicycle to and from riding areas. Sometimes a single bicycle is transported and sometimes multiple bicycles are transported on the same vehicle.

Bicyclists can chose from a variety of bicycle transport racks designed to attach to vehicle roof tops, pickup truck beds, and on the rear vehicle hitch.

The present invention is related to commonly available bicycle racks designed to transport bicycles on vehicle roof tops and above pickup truck beds. These commonly available bicycle racks perform well and are widely used. But, they do present a few drawbacks. The roof top and above the pickup truck bed bicycle racks available today require the person to load and unload the bicycles from the sides of the vehicle which limits the bicycle capacity to two, or presents extreme loading and unloading challenges if more than two bicycles are transported. Due to these bicycle racks requiring the person to load and unload the bicycle from the side of the vehicle, the inside middle cargo areas of the vehicle are very difficult to reach rendering them practically unavailable for transporting bicycles. Another drawback of the current bicycle racks is their requirement that the bicycle be lifted above the rack and then lowered down onto the rack before being secured for transport. This presents a challenge when loading and unloading bicycles onto vehicles of a higher cargo area. A third drawback of the current bicycle racks is their requirement that the cyclist has to lift and bear the bicycle's entire weight, this drawback is further realized when loading and unloading heavier electrically powered bicycles.

Considering the drawbacks of the bicycle racks in the art today available to bicyclists who desire to transport their bicycles on their vehicle roof top or over top of their pickup truck bed, there is a need in the art for a bicycle rack designed to easily carry more than two bicycles, a bicycle rack designed to reduce the height the bicycle has to be lifted to load and unload from the vehicle mounted rack, and a bicycle rack that is designed to effectively reduce the amount of the bicycle's weight the bicyclist is required to lift.

### BRIEF SUMMARY OF THE PRESENT INVENTION

The present invention is a novel vehicle mountable bicycle transport rack consisting of a horizontal platform mounted longitudinally on a vehicle for rolling the bicycle on and along during the loading and unloading processes, a set of horizontal raised rails on either side of and parallel with the platform to guide the bicycle along and to retain the bicycle within the confines of the platform during the loading and unloading processes, and front and rear wheel hoops that hold and stabilize the bicycle during the transport process.

The present invention employs a novel bicycle loading and unloading method that effectively reduces the weight of the bicycle as experienced by the person, reduces the height the bicycle is required to be lifted to, and affords equal access to all portions of the vehicle's cargo area and is comprised of loading the bicycle one wheel at a time from the front or from the rear of the vehicle by standing the bicycle on it's rear wheel in an upright position so that the bicycle's front wheel can be rested on the bicycle rack while the bicycle's rear wheel remains on the ground. Then the bicycle is lifted up and rolled onto and along the bicycle rack to the transport position.

The present invention, along with the novel bicycle loading and unloading method, solves the drawbacks of the bicycle transport racks available in the art today by reducing the amount of the bicycle's weight the person is required to bear, by reducing the height the bicycle is required to be lifted to fit it onto the rack, and by affording equal equal access to all portions of the vehicle's cargo area.

The present invention can transport multiple bicycles on a single vehicle by connecting multiple units of the novel bicycle rack depicted in this specification together to form a single multi-bicycle transport rack.

The present invention can also be designed and constructed as a single multi-bicycle transport unit by having the platform and front wheel holder elements permanently connected, braced, or constructed together, to forma single multi-bicycle transport rack. This configuration offers reduced manufacturing expenses by allowing lighter grade materials to be utilized while preserving the same technical load characteristics.

### DESCRIPTION OF THE DRAWINGS

FIG. 1 is an overhead right side perspective view of the Guiderail Bicycle Rack in the open state.

FIG. 2 is an overhead right side perspective view of the Guiderail Bicycle Rack in the closed state.

FIG. 3 is a right side profile view of the Guiderail Bicycle Rack, in the open state.

FIG. 4 is a right side profile view of the Guiderail Bicycle Rack, in the closed state.

FIG. 5 is an overhead right side perspective view of the Platform Assembly.

FIG. 6 is right side front perspective profile view of the Front Wheel Hoop Assembly.

FIG. 7 is an overhead right side perspective view of the Guide Rail Assembly.

FIG. 8 is an overhead front side perspective view of the Rear Wheel Hoop Assembly.

FIG. 9 is an overhead right side perspective view of the Crossbar Attachment Assembly.

FIG. 10 is a close up right side profile view of the Front Wheel Hoop Assembly showing more detail of the position locking arms.

FIG. 11 is a close up right side profile view of the Rear Wheel Hoop Assembly showing more detail of the arms and the guide rail sliders.

FIGS. 12 thru 19 illustrate the novel bicycle loading and unloading method (the unloading method is the reverse of the shown loading method).

FIG. 12 depicts the Rear Wheel Hoop Assembly lowered to the loading position.

FIG. 13 depicts the Front Wheel Hoop Assembly and the Guide Rail Assembly raised to the loading position.

FIG. 14 depicts the bicycle placed in an upright position with its front wheel in the air and its rear wheel on the ground.

FIG. 15 depicts the bicycle's front wheel resting on the Platform Assembly.

FIG. 16 depicts the bicycle's rear wheel being lifted off of the ground as the bicycle's front wheel is rolled further onto the Platform Assembly.

FIG. 17 depicts the bicycle's rear wheel being rolled up and onto the Assembly.

FIG. 18 depicts the bicycle being rolled to the forward transport position.

FIG. 19 depicts the Rear Wheel Hoop being closed up on the bicycle's rear wheel.

FIG. 20 depicts multiple bicycle racks with their front wheel hoops connected together to form a single unit to transport multiple bicycles on the same vehicle.

FIG. 21 depicts one example of a multiple bicycle rack as a single unit.

FIG. 22 depicts a single platform element for a multiple bicycle transport rack.

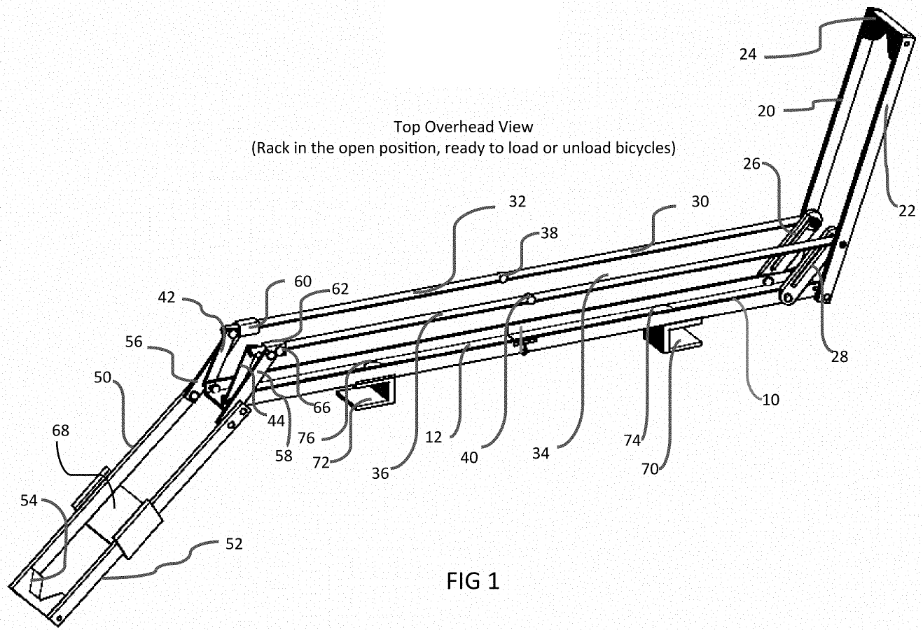

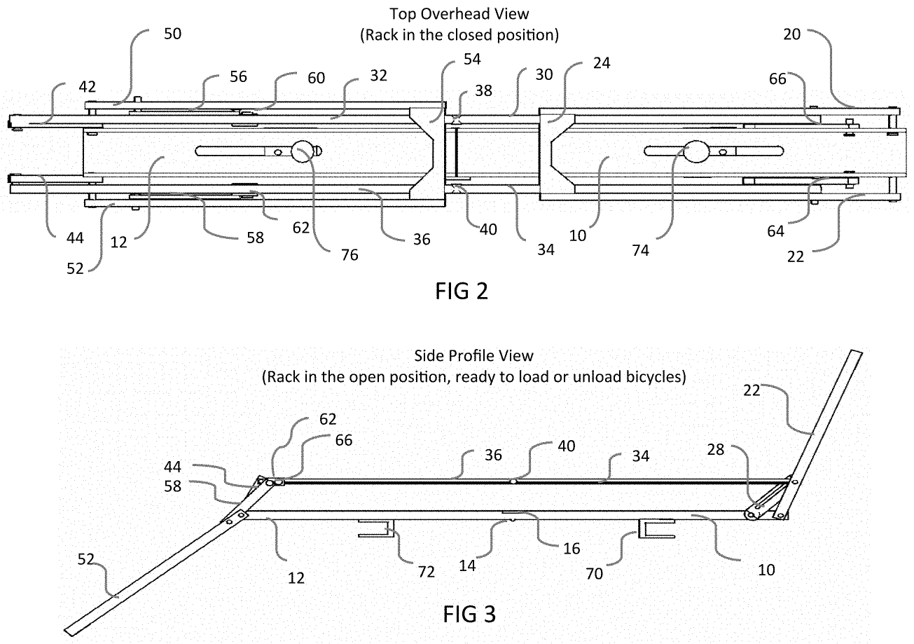

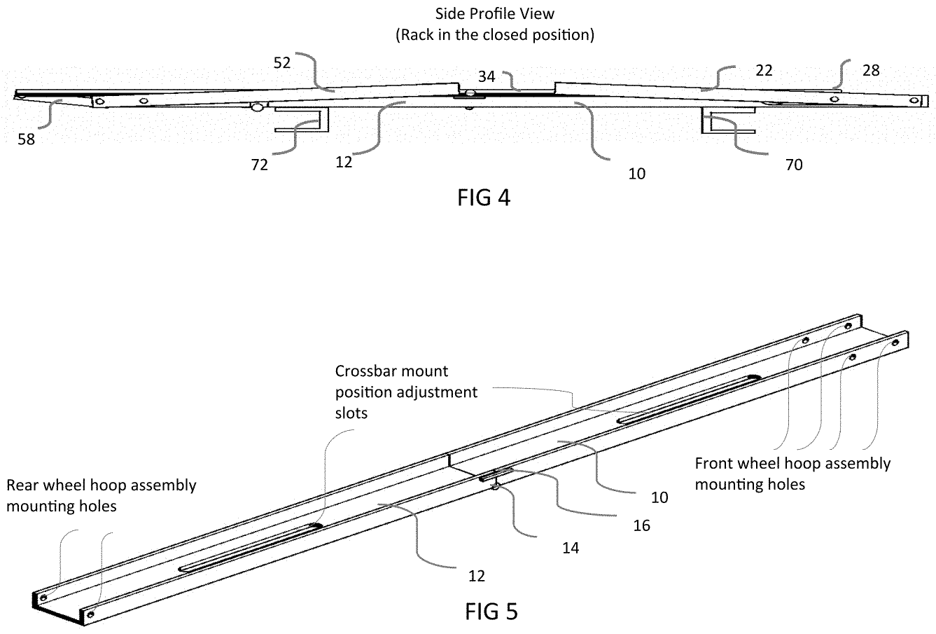

### DETAILED DESCRIPTION

The present invention, the Guiderail Bicycle Rack, herein interchangeably also referred to as “rack”, is designed to attach to a vehicle's crossbars, or luggage rack, and carry one or more bicycles in an upright position on vehicle roof tops or pickup truck beds. The present invention is designed to employ a novel bicycle loading and unloading method to effectively reduce the physical effort required to load and unload bicycles and to offer equal access to a vehicle's entire cargo area.

The present invention is a vehicle mountable bicycle transport apparatus comprised of five separate assemblies that once assembled together form a single unit designed to employ a novel bicycle loading and unloading method to overcome the difficult loading and unloading drawbacks of the currently available vehicle mountable bicycle transport apparatuses in the art.

The novel bicycle loading and unloading method employed by the apparatus solves the drawbacks of currently available apparatuses in the art, by reducing the amount of the bicycle's weight the person is required to bear, by reducing the height the bicycle is required to be lifted, and by affording equal access to all portions of the vehicle's bicycle transport area by allowing the person to load and unload the bicycle from the front or rear of the vehicle one wheel at a time as opposed to apparatuses in the art that require the person to load and unload the bicycle from the side of the vehicle both wheels at the same time.

The novel one wheel at a time from the front or rear of the vehicle bicycle loading and unloading method consists of loading and unloading the bicycle one wheel at a time from the front or from the rear of the vehicle by placing the bicycle in a near vertical upright standing position with the bicycle's front wheel up in the air and the bicycle's rear wheel resting on the ground surface; rolling the bicycle towards the vehicle mounted apparatus on its rear wheel, while still in the upright position, until the bicycle's front wheel can be placed on, into, within, against, or near the apparatus; lifting the bicycle's rear wheel off of the ground surface while at the same time rolling the bicycle's front wheel onto the apparatus; continuing to roll the bicycle onto the apparatus until the bicycle's rear wheel can be placed on, into, within, against, or near the apparatus; continuing to roll the bicycle onto the apparatus until both bicycle wheels are fully resting and fully inserted onto, or within, the apparatus.

The novel vehicle mountable bicycle transport apparatus represented by the present invention is formed by beginning with a longitudinally orientated horizontal Platform Assembly element that provides the surface, or platform, the bicycle is rolled on and along during the loading and unloading processes and provides the mounting locations and provisions for attaching the other four assemblies.

The Platform Assembly, FIG. 5, consists of a front 10 and a rear 12 upright “U” shaped channel platform section joined together by a hinge 14 and a latch 16. Hinge 14 permits the Platform Assembly, and the entire assembled unit to be folded to reduce the amount of space required to store the rack. Latch 16 locks, or secures, the Platform Assembly in the open unfolded condition.

In one embodiment, the Platform Assembly can consist of an upright “U” shaped channel in one or more sections as shown in FIG. 5 or in another embodiment, the Platform Assembly can consist of a single flat solid, perforated, mesh, or screen surface platform to serve as the platform element for all bicycle transport positions of a multi-bicycle rack as shown in FIG. 22. The single large platform element in this embodiment would allow additional storage and transport capacity between the bicycle transport positions for bicycle related and for non-bicycle related items. This other embodiment of the present invention would also be comprised of the multiple Front Wheel Hoop Assemblies being connected to one another and acting as one single multi-bicycle Front Wheel Hoop Assembly. This alternated Front Wheel Hoop Assembly arrangement would add significant strength to the unit as a whole due to each individual bicycle transport position and being effectively braced by the neighboring bicycle transport positions. This other embodiment would take advantage of this added strength to make use of lighter, less expensive materials.

A Front Wheel Hoop Assembly element attaches to one end of the Platform Assembly and establishes the bicycle's forward travel stopping point along the Platform Assembly and works in conjunction with a Rear Wheel Hoop Assembly to provide transverse and longitudinal stability for the bicycle during the transport process.

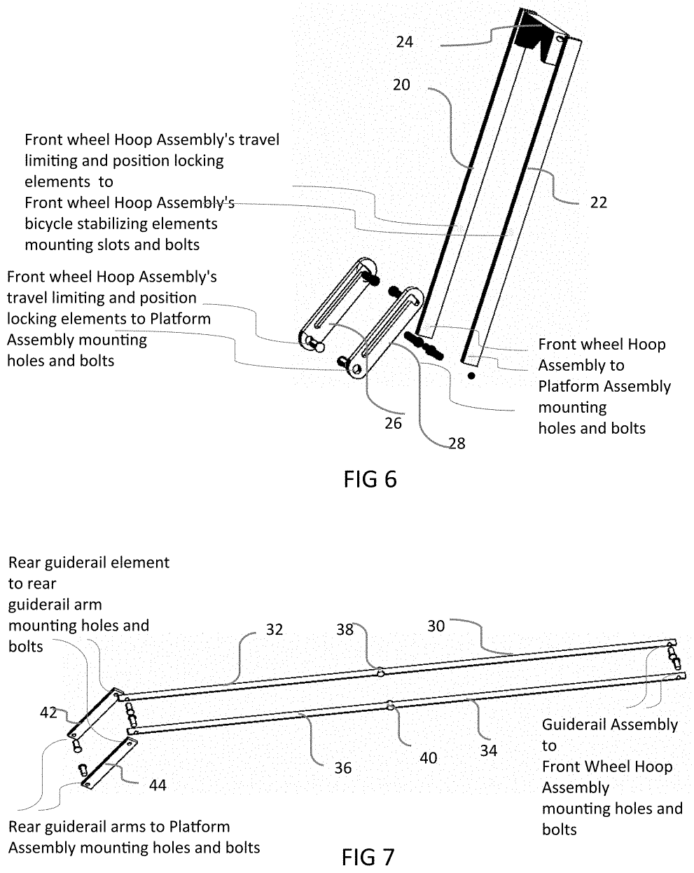

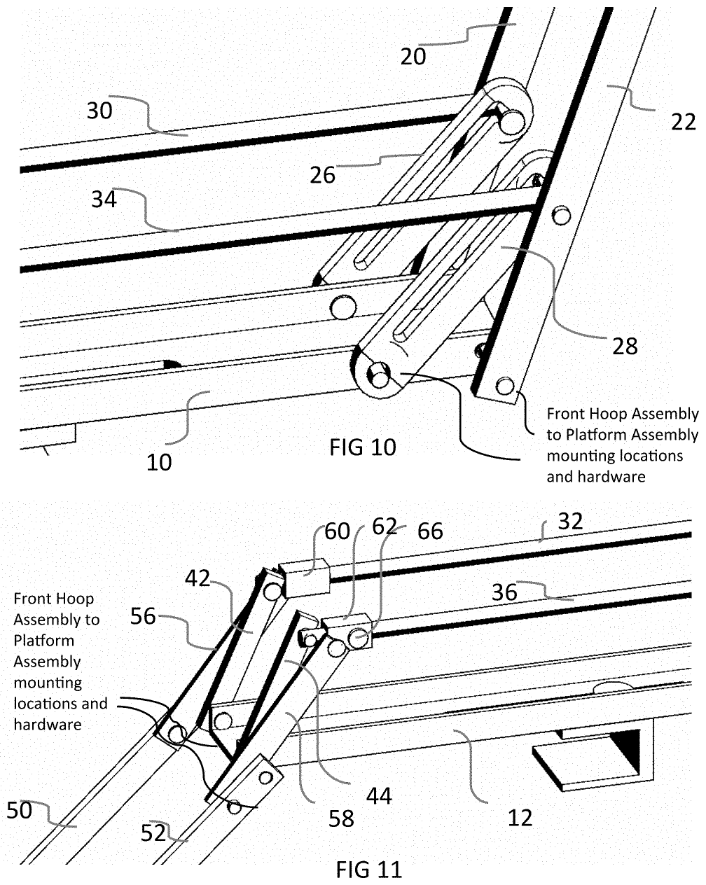

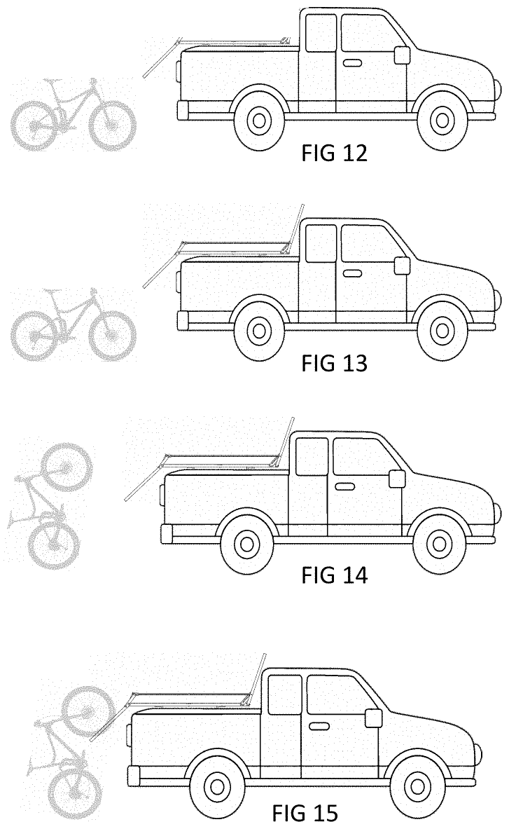

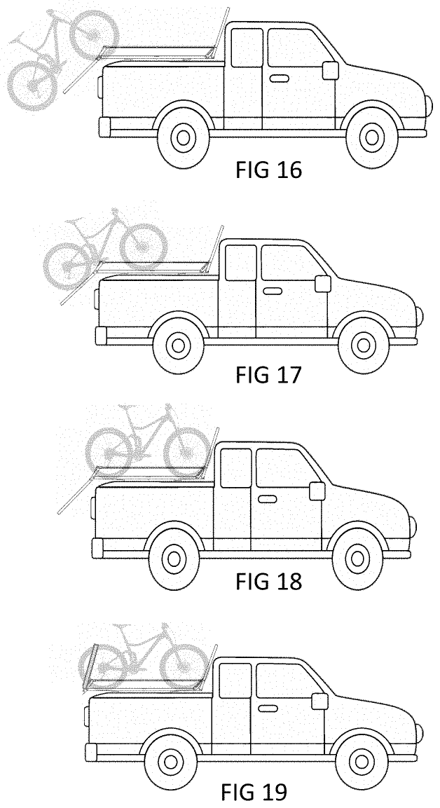

The Front Wheel Hoop Assembly, FIG. 6 and FIG. 10, consists of left 20 and right 22 stabilizer arms joined together on one end by a bicycle wheel holder 24 and mount moveably and rotationally on the other end to platform section 10 by inserting joining hardware through a mounting hole in platform section 10 and stabilizer arms 20 and 22 as depicted in FIG. 6 and FIG. 10.

The Front Wheel Hoop Assembly also consists of a left 26 and a right 28 travel limiter and locker arm. The travel limiter and locker arms 26 and 28 mount moveably and rotationally on one end to platform section 10 by inserting joining hardware through a mounting hole in platform section 10 and travel limiter and locker arms 26 and 28 and mount on the other end to the stabilizer arms 20 and 22 by inserting joining hardware through an open slot in the travel limiter and locker arms 26 and 28 and a hole in stabilizer arms 20 and 22 as depicted in FIG. 6 and FIG. 10.

A Guide Rail Assembly element attaches on one end to the Front Wheel Hoop Assembly and on the other end to the Platform Assembly and provides longitudinal orientated raised horizontal rails on either side of the Platform Assembly to guide the bicycle along and to retain the bicycle within the confines of the Platform Assembly during the loading and unloading processes.

The Guide Rail Assembly, FIG. 7, consists of left front 30 and a left rear 32 rail elements joined together by hinge 38, right front 34 and right 36 rear rail elements joined together by hinge 40, left position arm 42 and right position arm 44. The Guide Rail Assembly attaches moveably and rotationally to the Front Wheel Hoop Assembly on one end by inserting the same joining hardware used to join the stabilizer arms 20 and 22 to the travel limiter and locker arms 26 and 28 of the Front Wheel Hoop Assembly through a mounting hole in left front rail element 30 and right front rail element 34 as depicted in FIG. 10 and mounts moveably and rotationally on the other end to platform section 12 by inserting joining hardware through a mounting hole in platform section 12 and a mounting hole on one end of position arms 42 and 44. The position arms 42 and 44 attach moveably and rotationally to rail elements 32 and 36 by inserting joining hardware through a hole in one end of position arms 42 and 44 and a hole in rear rail elements 32 and 36 as depicted in FIG. 11. Hinges 38 and 40 allow the Guide Rail Assembly to fold with the Platform Assembly when the rack assembly is folded to reduce the required storage space.

The Guide Rail Assembly is automatically moved from the stored position to the loading position by the action of stabilizer arms 20 and 22 pulling the Guide Rail Assembly form its stored position to its open position when the Front Wheel Hoop Assembly is rotated from the stored position to the loading position.

A Rear Wheel Hoop Assembly element attaches to one end of the Platform Assembly and works in conjunction with the Front Wheel Hoop Assembly to provide transverse and longitudinal stability for the bicycle and to provide a clamping force to securely hold, or retain, the bicycle on and within Platform Assembly during the transport process.

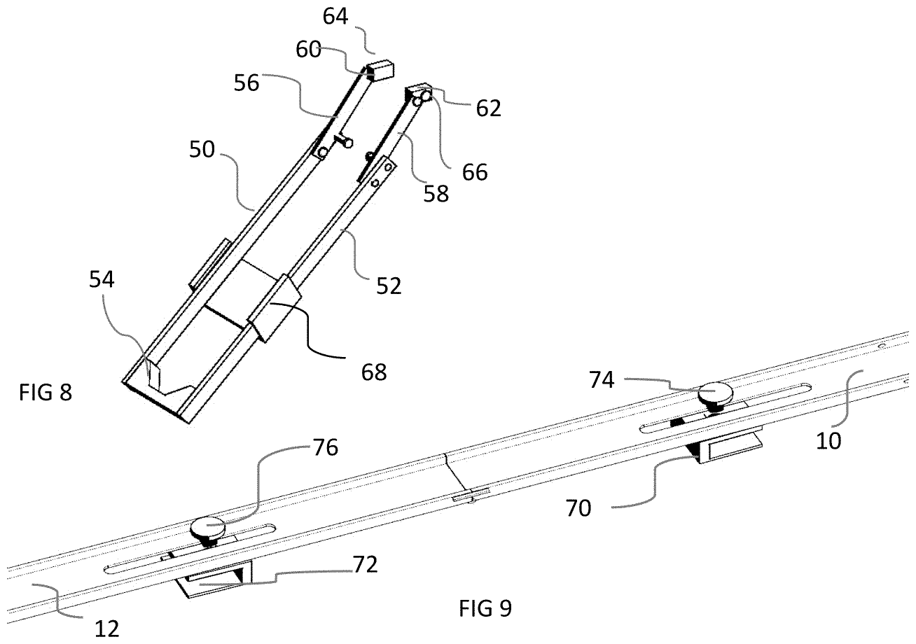

The Rear Wheel Hoop Assembly consists of a left 50 and right 52 stabilizer arm joined together on one end by a bicycle wheel holder 54 and mount moveably and rotationally on the other end to platform section 12 by inserting joining hardware through a mounting hole in platform section 12 and stabilizer arms 50 and 52 as depicted in FIG. 8 and FIG. 11.

The Rear Wheel Hoop Assembly also consists of a left 56 and a right 58 travel limiter arm, a left guide rail slider 60 and a right guide rail slider 62, a left guide rail slider set screw 64 and a right guide rail slider set screw 66. The travel limiter arms 56 and 58 mount moveably and rotationally on one end to guide rail sliders 60 and 62 by inserting joining hardware through a mounting hole in travel limiter arms 56 and 58 and threaded into a threaded hole in guide rail sliders 60 and 62 and mount on the other end to the stabilizer arms 50 and 52 by inserting joining hardware through a mounting hole in the travel limiter arms 56 and 58 and a hole in stabilizer arms 50 and 52 as depicted in FIG. 11. Guide rail sliders 60 and 62 fit onto and around the guide rail elements 32 and 36 so that as the Rear Wheel Hoop Assembly is rotated about its mounting point on platform section 12 the travel limiter arms 56 and 58 push and pull guide rail sliders 60 and 62 along the length of guide rail elements 32 and 36. Set screws 64 and 66, known in the hardware art as “thumb” screws or bolts, serve to hold the Rear Wheel Hoop Assembly in any position from its fully open loading and unloading position to its fully closed stored position by threading into the surface of guide rails sliders 60 and 62 and against guide rail elements 32 and 36 to apply pressure to and between the guide rail sliders 60 and 62 and the guide rail elements 32 and 36, the tightening force applied to guide rail elements 32 and 36 prevents the guide rail sliders from moving along the guide rail elements 32 and 36 thus preventing the stabilizer arms 50 and 52 from moving.

The Rear Wheel Hoop Assembly is further comprised of sliding bicycle wheel support element 68 that provides a bicycle wheel rolling surface for installations where the Platform Assembly is too high above ground level for the bicycle's front wheel to be capable of reaching the Platform Assembly while the bicycle's rear wheel is still in contact with the ground surface. This provides a rolling surface for the bicycle wheels to roll on while the bicycle is being lifted up and rolled onto the platform elements. Sliding bicycle wheel support 68 is fitted loosely onto the rear stabilizer arms 20 and 22 and slides down to a stopping point midway along the length of stabilizer arms 20 and 22 when the Rear Wheel Hoop Assembly is rotated to the open position. Sliding bicycle wheel support 68 slides to the Platform Assembly end of stabilizer arms 20 and 22 when the Rear Wheel Hoop Assembly is rotated up towards the closed position so that sliding bicycle wheel support 68 doesn't interfere with the Rear Wheel Hoop Assembly's task of fitting over the bicycle's rear wheel during the transport process.

A Crossbar Attachment Assembly element is mounted to the Platform Assembly to provide moveable and adjustable mounting brackets to attach the apparatus to the vehicle's crossbars or luggage rack.

The Crossbar Attachment Assembly consists of a front 70 and a rear 72 crossbar mounting brackets and a front 74 and a rear 76 crossbar bracket set screws. The crossbar brackets 70 and 72 are attached to the underside platform sections 10 and 12 by inserting the “screw” portion of set screws 74 and 76 through the top of the mounting slots in the surface of platform sections 10 and 12 and threading into the mounting holes in the crossbar brackets 70 and 72. Set screws 74 and 76 are what are know in the hardware art as “thumb” screws or bolts.

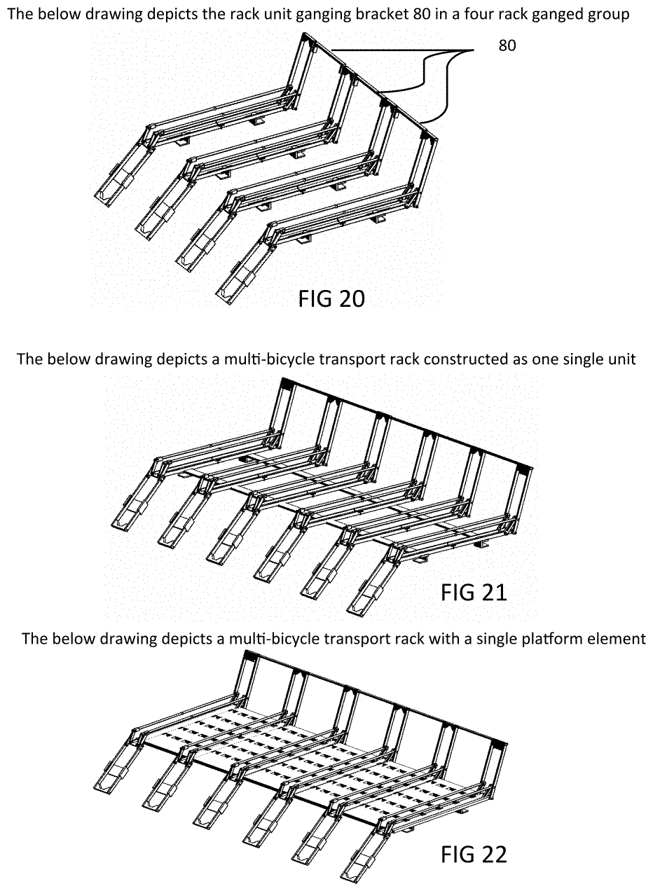

Multiple Guide rail Bicycle Racks installed on a vehicle can be connected together by connecting bracket 80 as seen in FIG. 20 to create a multi-bicycle single unit. This configuration allows the Front Wheel Hoop Assemblies of the inside rack units to be operated by the action of either of the outside rack unit's Front Wheel Hoop Assembly being operated, thereby eliminating the need for the person to reach over the outside rack units to open and close the Front Wheel Hoop Assemblies of the inner rack units.

The Guiderail Bicycle Rack is operated by first unlocking latch 16 and unfolding the rack assembly. Followed by placing the rack assembly longitudinally on top of the vehicle's cross bars or luggage rack with the Front Wheel Hoop Assembly towards the front or the rear of the vehicle. Next, the front crossbar bracket 70 is adjusted within the front platform 10's slot so that the forward edge of the rack is in the correct position relative to the vehicle crossbars and secured with the set screw 74. Then, the rear crossbar bracket 72 is moved rearward along the rear platform's slot until the crossbar bracket engages the rear crossbar with enough pressure to securely attach the rack to the crossbars and secured with the set screw 76. Now that the bicycle rack has been securely attached to the vehicle, it can be prepared for loading a bicycle by first raising and rotating the Rear Wheel Hoop Assembly to the rearward open position until the travel limiter arms 56 and 58 reach their travel limit. Next, the Front Wheel Hoop Assembly is lifted and rotated to the forward open position until the travel limiter locker arms 26 and 28 engage and hold the Front Wheel Hoop in the transport position. The action of the Front Wheel Hoop Assembly moving to its open position also automatically moves the Guide rail Assembly to its raised open position. The rack is now ready to accept a bicycle by using the novel one wheel at a time from the front or from the rear of the vehicle bicycle loading and unloading method. Once the bicycle is fully loaded onto the rack assembly, the Rear Wheel Hoop Assembly is closed up on the bicycle's rear wheel. While applying sufficient forward pressure with the Rear Wheel Hoop Assembly against the bicycle's rear wheel, the Rear Wheel Hoop Assembly is secured in position by tightening set screws 64 and 66. Unloading is the reverse of the loading procedure.

Alternate embodiments, or alterations, of the present invention include, but not limited to, the following:
1. A Front Wheel Assembly with gears on the stabilizing arm and the travel limiter locker arm pivot/rotation points so that the Front Wheel Hoop Assembly and the Guide rail Assembly can be opened and closed automatically when the Rear Wheel Hoop Assembly is opened and closed.
2. The Rear Wheel Hoop Assembly's guide rail sliders can be changed to, or replaced by, ratcheting automatic locking mechanisms.
3. A brace, bracket, arm, tube, or bolt 80 can be added to the Front Wheel Hoop Assembly so that the front wheel hoops of multiple racks can be connected together FIG. 20. This allows all the individual racks on a vehicle to be opened and closed by the action of opening and closing any one of the member racks.
4. The Guiderail Bicycle Rack can be designed and constructed with the Front Wheel Hoop Assembly and the Guide rail Assembly in a fixed open position.
5. The Guiderail Bicycle Rack can be designed and constructed as a single multi-bicycle position transport rack, FIG. 21, capable of transporting multiple bicycles where the Platform and Rear Wheel Hoop Assemblies would be connected together and operating as one single unit. This would allow lighter, less expensive materials to be used due to the added strength of all the various elements being supported and braced by the interconnection elements. The Rear Wheel Hoop Assemblies would remain independent elements so each can be closed and adjusted the proper amount to accommodate the bicycle size it is responsible for securing to the platform element.
6. The multiple bicycle Guiderail Bicycle Rack and be designed and constructed with a single platform to serve as the platform element for all bicycle transport positions of the multiple bicycle transport rack. This single platform element can also serve to add additional transport space and capability for items other than bicycles, depicted in FIG. 22.

What is claimed is:

1. A vehicle mountable bicycle transport rack comprising:
a platform element to receive a bicycle and to provide a rolling surface for said bicycle's wheels;
a guiding and retention element extending upward from and parallel with said platform element on either side of said platform element for guiding and retaining said bicycle wheels along and within the confines of said platform element and to maintain said bicycle in an upright position;
a front holding and support element extending upward from the fore end of said platform element for engaging the front wheel of said bicycle and to hold said bicycle in an upright position;
a rear holding and support element extending upward from the aft end of said platform element for engaging the rear wheel of said bicycle to hold said bicycle in an upright position;
a latch element comprising a plurality of interconnected arms pivoted on the sides of said platform element and pivoted on the said front holding and support element to hold the front holding and support element in the bicycle transport position;
a latch element comprising a plurality of interconnected arms pivoted on the sides of said platform element and pivoted on the said rear holding and support element to hold the rear holding and support element in the bicycle transport position; and
an interconnection element connectable to and between two or more said bicycle transport racks to provide a means of operating one or more said bicycle racks by the operating action of one or more other said bicycle racks;

2. Said vehicle mountable bicycle transport rack of claim 1, further comprising axels, or other hardware, to provide a rotational mounting means for the said front and rear holding and support elements to said platform element joint so that the said front and rear holding and support elements can be rotated to a closed non-use storage position and/or rotated to an open transport position.

3. Said vehicle mountable bicycle transport rack of claim 1, further comprising axels, or other hardware, to provide a rotational mounting means for the said guiding and retention element to said aft end of said platform element and to said front holding and support element joints so that the said guiding and retention element can be automatically moved to and from a lower stored position to a raised transport position by the action of said front holding and support element rotating to and from the stored position and the transport position.

2. An alternate embodiment of the said platform element consisting of a single flat platform to provide the rolling surface for multiple bicycles and to provide the mounting locations and provisions for multiple said front and rear holding and support elements.

3. A bicycle loading and unloading method, said method comprising:
a positioning of a bicycle consisting of placing said bicycle in an upright vertical position with said bicycle's front wheel in the air and said bicycle's rear wheel on the ground surface;
a positioning of said bicycle's front wheel consisting of placing said bicycle's front wheel on, up on, within, against, or near a bicycle transport rack;
a lifting of said bicycle's rear wheel consisting of lifting said bicycle's rear wheel off the ground surface while simultaneously, or nearly simultaneously, rolling said front bicycle wheel further on, onto, or within said bicycle transport rack;
a positioning of said bicycle's rear wheel consisting of lifting said rear bicycle wheel further as said bicycle's front wheel is rolled further onto, or along said bicycle rack until said rear bicycle wheel can be placed on, up on, within, against, or near said bicycle rack;
a positioning of said bicycle in said bicycle rack's transport position consisting of rolling said bicycle's front wheel and said bicycle's rear wheel on and along said bicycle rack until said bicycle is positioned in the said bicycle rack's transport position; and
a reversing of said loading steps consisting of reversing said steps to unload said bicycle from said bicycle rack.
